(19) United States
(12) Patent Application Publication
(10) Pub. No.: US 2024/0176828 A1
(43) Pub. Date: May 30, 2024

(54) DATA COLLECTION APPARATUS, DATA COLLECTION METHOD, AND PROGRAM

(71) Applicant: NEC Corporation, Tokyo (JP)

(72) Inventors: Yuki Ashino, Tokyo (JP); Takashi Hitani, Tokyo (JP); Miyu Yakumaru, Tokyo (JP)

(73) Assignee: NEC Corporation, Tokyo (JP)

(21) Appl. No.: 18/508,747

(22) Filed: Nov. 14, 2023

(30) Foreign Application Priority Data
Nov. 25, 2022 (JP) 2022-187972

(51) Int. Cl. G06F 16/951

(52) U.S. Cl. CPC G06F 16/951

(57) ABSTRACT

There is provided a data collection apparatus including: a collection target holding part that holds collection targets for data collection; a collection policy holding part that holds collection policies for data collection; and a collection part that collects data from the collection targets on the basis of the collection policies, wherein the collection part collects data by switching the collection policy to be applied on the basis of another collection policy that defines how the collection policies are applied.

### REFERENCE TO RELATED APPLICATION

The present invention is based upon and claims the benefit of the priority of Japanese patent application No. 2022-187972 filed on Nov. 25, 2022, the disclosure of which is incorporated herein in its entirety by reference thereto.

### FIELD

The present invention relates to a data collection apparatus, data collection method, and program.

### BACKGROUND

It is necessary to collect a large amount of data in order to process an enormous amount of data and perform “analysis” to extract meaningful data. For instance, it is possible to automatically retrieve and collect content by browsing websites on the internet. In order to extract meaningful information from such collected data, however, one cannot avoid gathering a vast amount of irrelevant information that far exceeds meaningful data.

Patent Literature (PTL) 1 discloses an invention of a collection apparatus for collecting data on a server via a network. This technology provides fast and efficient means for addressing network or device failures or network congestion when acquiring data in a tree structure such as a directory structure. Concretely, for instance, by keeping access information that includes a data access history when the data is collected, if the connection is lost for some reason, it is possible to refer to the access information and resume collection from the data that should be accessed next after an interruption. Further, by monitoring and analyzing the data collection status, it is possible to increase or decrease the number of parallel data collection instances when the amount of data to be collected increases.

[PTL 1]

Japanese Patent Kokai Publication No. JP-P2018-182420A

### SUMMARY

The disclosure of the literature in Citation List above is incorporated herein in its entirety by reference thereto. The following analysis is given by the present inventors.

As described above, according to the invention of Patent Literature 1, in a case where the performance of data collection changes up and down through factors such as the network environment, it is possible to execute a most efficient data collection process in a given situation by changing the data collection policy according to the situation.

Such efficient data collection results in a large amount of data being stored in a collection apparatus. However, no matter how large the capacity of a storage device is, the storage of the collection apparatus is finite, limiting the amount of information that can be collected. Therefore, from the viewpoint of collecting meaningful information, it is necessary to provide more advanced means for collecting information. In other words, rather than randomly collecting data and then analyzing the collected data, it is desired to collect meaningful information with high efficiency even by using a limited storage space.

Therefore, it is an object of the present invention to provide a data collection apparatus, data collection method, and program that contribute to collecting meaningful information with high efficiency in a finite storage space.

According to a first aspect of the present disclosure, there is provided a data collection apparatus. The data collection apparatus comprises: a collection target holding part that holds collection targets for data collection; a collection policy holding part that holds collection policies for data collection; and a collection part that collects data from the collection targets on the basis of the collection policies, wherein the collection part collects data by switching the collection policy to be applied on the basis of another collection policy that is different from the collection policies and that defines how the collection policies are applied.

According to a second aspect of the present disclosure, there is provided a data collection method. The data collection method includes: causing a computer to acquire collection targets for data collection; causing the computer to acquire collection policies for data collection; causing the computer to collect data from the collection targets on the basis of the collection policies; and causing the computer to collect the data by switching the collection policy to be applied on the basis of another collection policy that is different from the collection policies and that defines how the collection policies are applied.

According to a third aspect of the present invention or the present disclosure, there is provided a program causing a computer to execute: acquiring collection targets for data collection; acquiring collection policies for data collection; collecting data from the collection targets on the basis of the collection policies; and collecting the data by switching the collection policy to be applied on the basis of another collection policy that is different from the collection policies and that defines how the collection policies are applied.

According to each aspect of the present disclosure, the present invention provides a data collection apparatus, data collection method, and program that contribute to collecting meaningful information with high efficiency in a finite storage space.

### BRIEF DESCRIPTION OF THE DRAWINGS

FIG. 1 is a block diagram showing an example of the configuration of a data collection apparatus relating to one example embodiment.

FIG. 2 is a block diagram showing an example of the configuration of a data collection apparatus relating to a first example embodiment.

FIG. 3 is a drawing showing an example of collection targets held in a collection target holding part.

FIGS. 4A and 4B are drawings showing examples of collection policies.

FIG. 5 is a conceptual diagram for explaining the processing times of data collection processes due to differences in the collection policies.

FIG. 6 is a drawing showing a data collection history of the data collection apparatus relating to the first example embodiment.

FIG. 7 is a drawing for explaining the configuration of an editing part of the data collection apparatus relating to the first example embodiment.

FIG. 8 is a flowchart showing an example of the operation of the data collection apparatus relating to the first example embodiment.

FIG. 9 is a drawing illustrating an example of the hardware configuration of the data collection apparatus relating to the first example embodiment.

FIG. 10 is a block diagram showing an example of the configuration of a data collection apparatus relating to a second example embodiment.

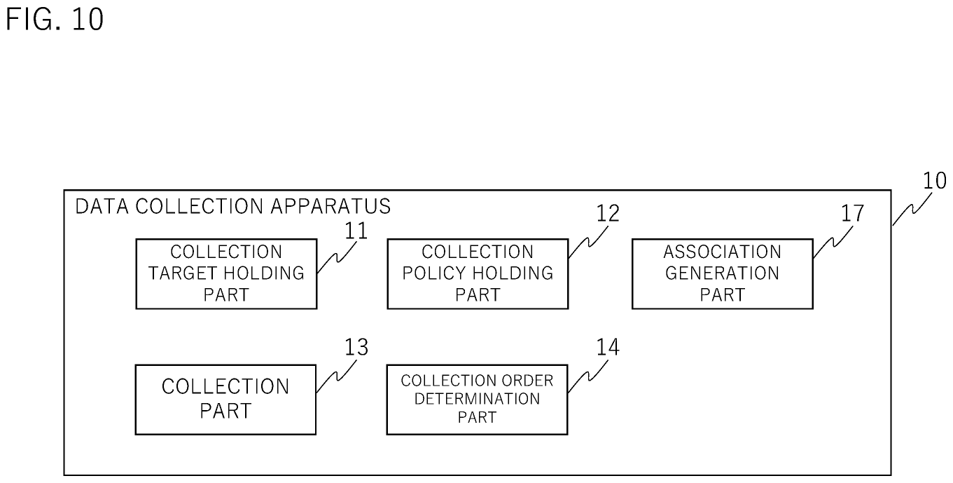

FIG. 11 is a flowchart showing an example of the operation of the data collection apparatus of the second example embodiment.

### EXAMPLE EMBODIMENTS

First, an outline of an example embodiment will be given. It should be noted that the drawing reference signs in the outline are given to each element for convenience as an example to facilitate understanding, and the description in the outline is not intended to limit the present invention. Further, connection lines between blocks in each drawing can be both bidirectional and unidirectional. A unidirectional arrow schematically shows the main flow of a signal (data) and does not exclude bidirectionality. Moreover, in circuit diagrams, block diagrams, internal configuration diagrams, and connection diagrams shown in the disclosure of the present application, the input and output ends of each connection line have an input port and an output port, respectively, although not shown explicitly. The same applies to input/output interfaces.

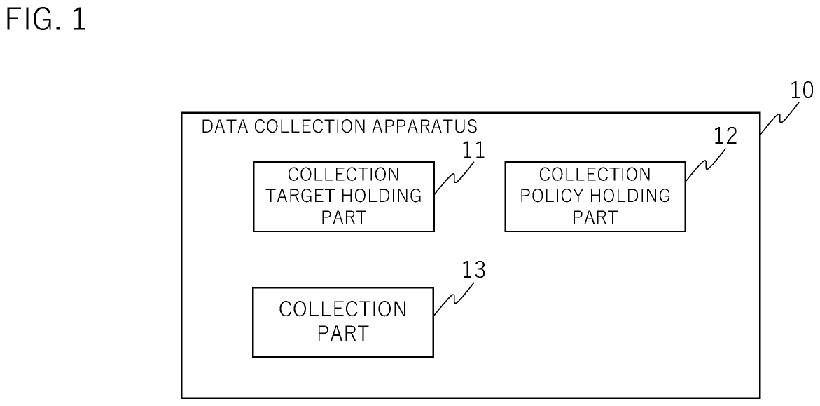

FIG. 1 is a block diagram showing an example of the configuration of a data collection apparatus relating to an example embodiment. As shown in the drawing, the data collection apparatus 10 relating to an example embodiment has a collection target holding part 11, a collection policy holding part 12, and a collection part 13.

The collection target holding part 11 holds collection targets for data collection. The collection policy holding part 12 holds collection policies for data collection. The collection part 13 collects data from the collection targets on the basis of the collection policies.

On the basis of another collection policy that is different from the collection policies and that further defines how the collection policies are applied, the collection part 13 collects data by switching the collection policy to be applied. Here, as the other collection policies, “another collection policy” is also a policy for data collection, which is held in the collection policy holding part. It is a highly strategic, higher-level policy that determines how the policies are When data is collected, first a higher-level selected and applied.

collection policy may be selected, and then a lower-level policy to be applied may be determined on the basis of the selected higher-level policy.

The data collection apparatus 10 of an example embodiment is capable of collecting data from the collection targets on the internet held in the collection target holding part 11 on the basis of the collection policies held in the collection policy holding part 12. The collection policies are switched by the collection part 13 according to the collection target. As a result, it becomes possible to perform data collection optimized for various data content and structures of the collection targets and collect meaningful information with high efficiency.

Concrete example embodiments will be described in more detail with reference to the drawings. Note that the same reference signs are given to the same elements in each example embodiment, and the description thereof will be omitted.

### First Example Embodiment: Configuration

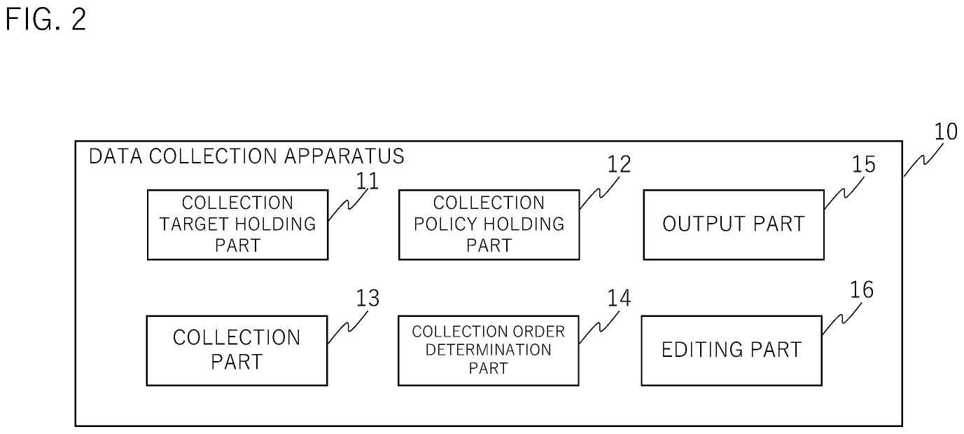

As shown in FIG. 2, the data collection apparatus 10 of the present example embodiment, as in an example embodiment described above, has the collection target holding part 11, the collection policy holding part 12, and the collection part 13. The data collection apparatus 10 of the present example embodiment further has a collection order determination part 14, an output part 15, and an editing part 16.

The collection target holding part 11 holds collection targets for data collection. The “data” of the “data collection” includes, for instance, content data on websites and SNS (Social Networking Services) on the internet, and the “collection” refers to a series of processes of acquiring data and storing the acquired data in storage by automatically browsing and accessing websites and SNS on the internet.

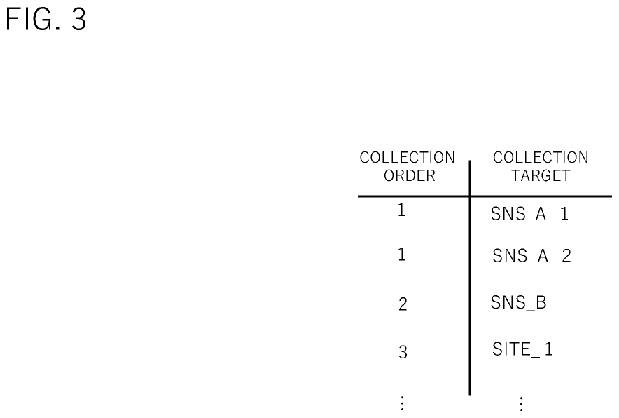

FIG. 3 is a drawing showing an example of the collection targets held in the collection target holding part 11. As shown in the drawing, each collection target is stored in association with its collection order. The collection order is sequentially assigned to each collection target from 1. When the same collection order is duplicated as in the drawing where the collection order of 1 is repeated, data collection may be performed in parallel. The collection targets are data on the internet including, for instance, content on SNS (SNS_A or SNS_B in the drawing) and websites (SITE_1 in the drawing).

With respect to the collection targets, for instance, SNS_A is divided into SNS_A_1 and SNS_A_2, which may refer to different collection targets. In a case of an SNS, for instance, they may refer to different accounts on the same SNS.

The collection policy holding part 12 holds collection policies for data collection. The “collection policy” is a concept that includes a strategy for collecting content, collection procedure, collection rule, concrete collection process, and the like. In other words, as described above, the “collection policies” may be defined hierarchically from top to bottom, and there may be a different, higher-level collection policy defined to determine how policies are applied.

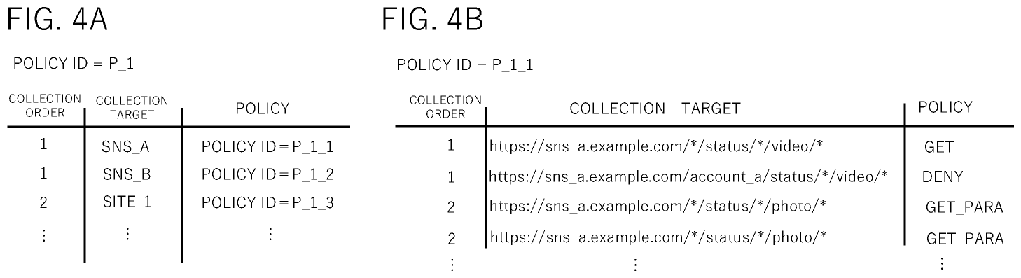

FIGS. 4A and 4B are drawings showing examples of the collection policies. As shown in the drawing, the policies are associated with the collection targets. In FIG. 4A, the policy ID is P_1. Lower-level policies defining collection targets and collection orders applied to each collection target are shown. FIG. 4B defines a lower-level policy (policy ID P_1_1) applied to the policy P_1. Policies applied in the policy P_1_1 are specific collection processes such as GET and DENY. The collection policies are thus structured hierarchically, and one collection policy may call another.

The policy P_1_1 defines policies for collecting data from SNS_A (URL: https://sns_a.example.com), stating that, at Collection Order 1, video content is acquired from all available entries on SNS_A's accounts and at the same time data from an account A (account_a) is denied as an exception. Then, at Collection Order 2, photographs are obtained from all available entries on SNS_A's accounts. It goes without saying that some social networking services may limit the amount of data that can be obtained at a time, and this relates to a matter of design choice.

It should be noted that the policies described above are examples and the collection policies are not limited thereto. For instance, the policy P_1_1 assumes connection via the HTTPS protocol, however, connection may be made via a different protocol. For instance, an API (Application Programming Interface) provided by each SNS may be used.

The collection part 13 collects data from the collection targets on the basis of the collection policies, scanning the policies, structured hierarchically as described above, from top to bottom, identifying the content to be collected ultimately, and executing a process such as collection according to the defined policies.

The collection order determination part 14 determines the order in which data are collected on the basis of the collection policy applied by the collection part 13 and the collection targets held by the collection target holding part 11. The determined order and the collection targets and policies associated therewith may be defined as new policies, such as the ones shown in FIG. 4B. For instance, if the content data of an account C on SNS_B is a collection target and the collection policy is to acquire text data rather than video or image data, it is possible to define a collection order policy that acquires text data first.

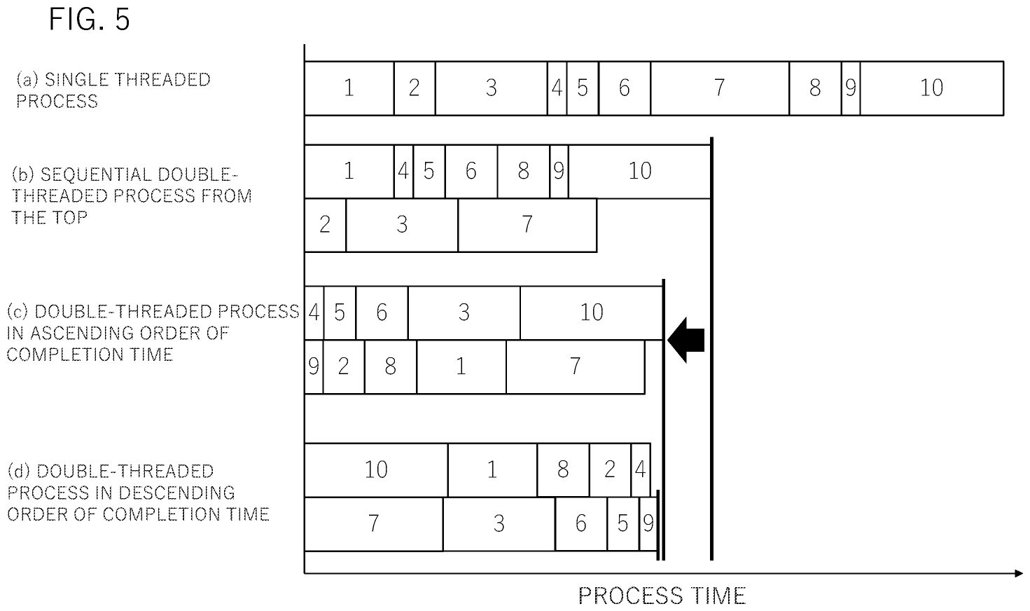

The collection policies may reflect various data acquisition strategies. FIG. 5 is a conceptual diagram for explaining the processing times of data collection processes due to differences in the collection policies in data collection. As shown in FIG. 5(b), by accessing the same collection target simultaneously in parallel with two threads, it is possible to reduce the processing time as compared with a single threaded process in FIG. 5(a). Concretely, for instance, as defined for Collection Order 2 in FIG. 4B, by setting two GET_PARA policies for the same collection target, a double-threaded collection process can be defined. Moreover, as shown in FIGS. 5(c) and 5(d), the collection process can be further expedited by defining the collection order in ascending or descending order of completion time and collecting data.

More concretely, if the collection order determination part 14 is able to obtain information regarding the size of files collected from the collection targets, the processes shown in FIGS. 5(c) and 5(d) are possible. Even if such processes are not possible, for instance, in the case of FIG. 5(c), the collection order may be determined so as to first collect text data that can be collected in a short period of time and then collect image data and video data in this order in a predetermined period of time. Alternatively, the policies may be defined so as to first collect video data and image data in this order and then collect text data, to reduce the total process time as in FIGS. 5(c) and 5(d) by determining the collection order.

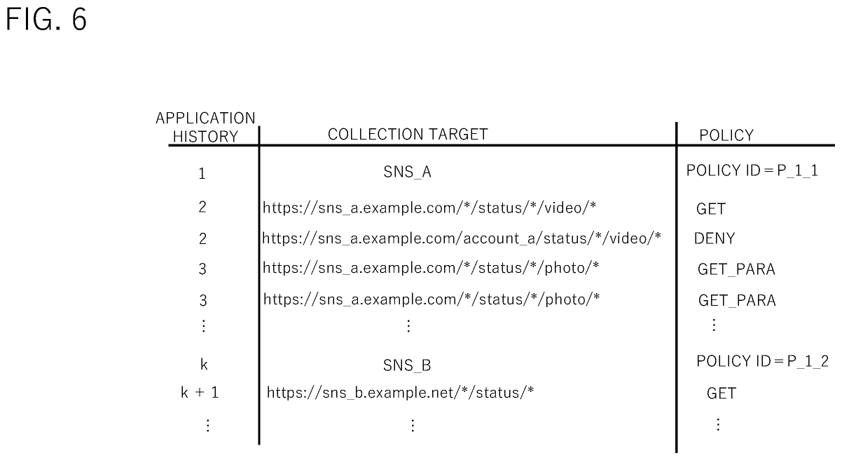

The output part 15 outputs a history of the policies applied to the collection part 13 and the collection targets. Concretely, the output part 15 outputs the information described below via a display device. FIG. 6 shows a data collection history of the data collection apparatus of the present example embodiment. Basically, the results of executing the policies shown in FIGS. 4A and 4B are outputted. First, at Application Event 1, in order to acquire data on SNS_A, the policy P_1_1 is called for. Next, throughout Application Events 2 to k−1, content data on SNS_A are collected on the basis of the policy P_1_1. The data collection apparatus started to obtain content data on SNS_B at the k-th application event when the applied policy was switched from the policy P_1_1 to a policy P_1_2.

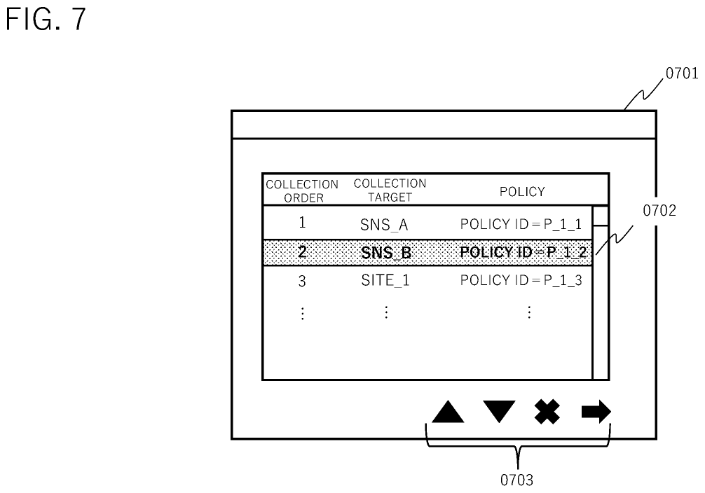

The editing part 16 edits a schedule of the policies applied to the collection part 13 and the collection targets. FIG. 7 is a drawing for explaining the configuration of the editing part 16 of the present example embodiment. The drawing shows an image of a data collection schedule displayed on a display device. The drawing displays policies corresponding to scheduled data to acquire the data of the collection targets. The definition of Collection Order 2 is currently selected (0702). One is able to operate on the selected definition 0702 by using operation buttons 0703 at the bottom of the drawing (▴▾: select order number above or below; ×: delete definition; →: insert new definition).

### Operation

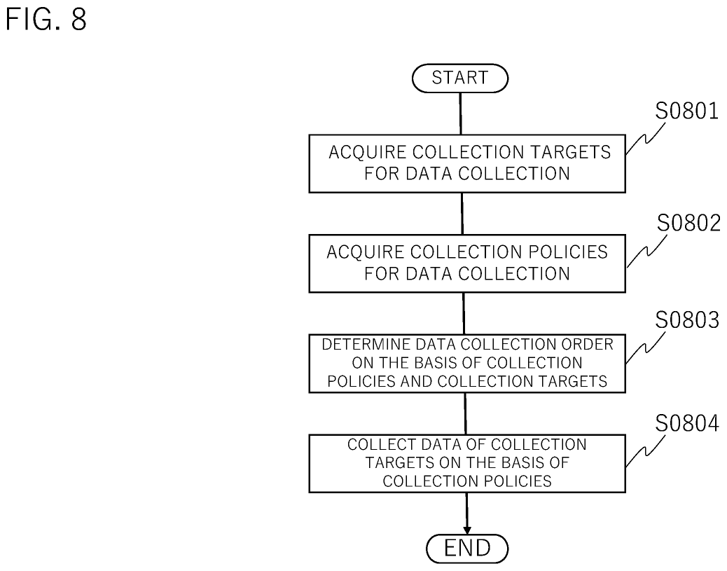

FIG. 8 is a flowchart showing an example of the operation of the data collection apparatus 10 relating to the present example embodiment. As shown in the drawing, the data collection apparatus 10 first acquires the collection targets for data collection (step S0801) and then obtains the collection policies for data collection (step S0802). After these steps are completed, the data collection order is determined on the basis of the collection policies and the collection targets (step S0803). Then, the data collection apparatus collects the data of the collection targets on the basis of the collection policies (step S0804).

Further, the process flow above may include a step of editing the collection policies and the collection order after the collection policies and the data collection order have been determined (the step S0803). In addition, the process flow may also include a step of outputting a history of the applied policies and the collection targets after the step of collecting the data of the collection targets (the step S0804).

### Hardware Configuration

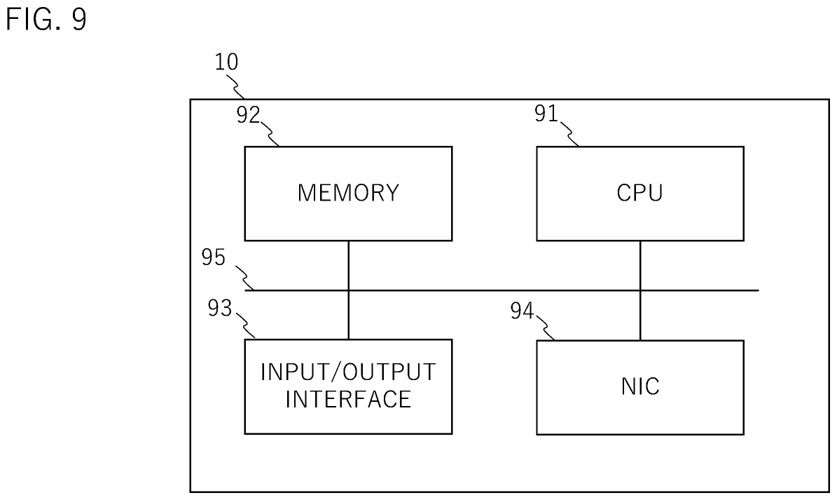

The data collection apparatus 10 of the present example embodiment can be constituted by an information processing apparatus (computer), which comprises a configuration illustrated in FIG. 9. For instance, the data collection apparatus 10 comprises a CPU (Central Processing Unit) 91, a memory 92, an input/output interface 93, and a NIC (Network Interface Card) 94, which is communication means. These elements are interconnected by an internal bus 95.

It should be noted that the configuration shown in FIG. 9 is not intended to limit the hardware configuration of the data collection apparatus 10. The data collection apparatus 10 may include hardware not shown in the drawing, and the input/output interface 93 may be omitted if unnecessary. The example of FIG. 9 is not intended to limit the number of CPUs, etc., included in the data collection apparatus 10, and for instance, a plurality of the CPUs may be included in the data collection apparatus 10.

The memory 92 is a RAM (Random Access Memory), ROM (Read-Only Memory), or auxiliary storage device (such as a hard disk).

The input/output interface 93 serves as an interface for a display device or an input device not shown in the drawing. An example of the display device is a liquid crystal display. The input device is, for instance, a device that receives user operations such as a touch panel, keyboard, or mouse.

The functions of the data collection apparatus 10 are realized by a set of programs (processing modules) such as a collection program, collection order determination program, output program, and editing program stored in the memory 92 and a set of data such as collection target data and collection policy data held in storage. For instance, these processing modules are realized by causing the CPU 91 to execute each program stored in the memory 92. These programs may be downloaded via a network or updated using a storage medium storing the programs. Further, the processing modules may be realized by a semiconductor chip. In other words, the functions performed by the processing modules may be executed by some kind of hardware and/or software means.

### Hardware Operation

When the data collection apparatus 10 starts to operate, the collection order determination program is first called by the CPU 91 from the memory 92 and starts to run. From the memory 92, the program reads the collection target data, such as the one shown in FIG. 3, and the collection policy data and determines the collection order. More concretely, the program generates the collection policy data as shown in FIG. 4A by combining the collection target data as shown in FIG. 3 and the collection policy data using the collection targets as keys. This process may be executed by receiving an operation via the input/output interface 93. In this case, the editing program is called by the CPU 91 from the memory 92 and executed.

Next, the CPU 91 calls the collection program from the memory 92 and executes it. The program accesses a highest-level root policy (for instance, the policy P_1 in FIG. 4A) and reads the collection order, the collection targets, and the applied policies. The program further reads down lower-level policies stated in the root policy P_1 to load the collection order, the collection targets, and the applied policies and then applies the policies on the loaded collection targets in the collection order. In FIGS. 4A and 4B, the policy P_1 in FIG. 4A is the root policy that applies the other policies in the collection order. First, the policies P_1_1 and P_1_2 are simultaneously applied, and data are collected by accessing the collection targets in the order stated in the policies P_1_1 and P_1_2 and applying policies such as GET, etc.

Once policies have been applied to all the collection targets in the policies P_1_1 and P_1_2, the program returns to the root policy, starting to apply a next policy P_1_3 defined for SITE_1 and executing policies on the collection targets listed in all the collection orders in P_1. The collection program performs data collection via the NIC 94 on the basis of the applied policies.

As described above, the data collection apparatus of the present example embodiment is characterized in that the collection part 13 collects data by switching the collection policy to be applied on the basis of a higher-level collection policy that defines how the collection policies are applied. As a result, it becomes possible to efficiently collect meaningful content for users.

### Second Example Embodiment

A second example embodiment describes how the applied policies are generated. As shown in FIGS. 4A and 4B, the policies are stored with the collection targets in association with the policies applied thereto. An association generation part 17 described later executes this association and generates policies.

### Configuration

As in the first example embodiment, the data collection apparatus 10 relating to the second example embodiment has the collection target holding part 11, the collection policy holding part 12, the collection part 13, and the collection order determination part 14. The data collection apparatus 10 of the present example embodiment is characterized in that the association generation part 17 is newly provided and the collection part 13 collects the data of the collection targets on the basis of the collection targets and the collection policies associated with each other.

The association generation part 17 generates the associations between the collection targets and the collection policies. By associating a collection target with a collection policy, a new policy is generated. An association may be generated by receiving an operation of the input/output interface 93. Alternatively, the association generation part 17 may generate an association on the basis of a predetermined condition according to the data status of a collection target. For instance, when the average number of images attached per post exceeds two on a particular SNS account within a predetermined period of time, a new policy may be created so as to collect only text data from posts on this account without collecting images. Or if the number of posts with media (video) in a day is five or more, a policy may state that the media will not be downloaded. Furthermore, a policy may be created so as not to download media when there are two or more media-only posts without text in a day.

### Operation

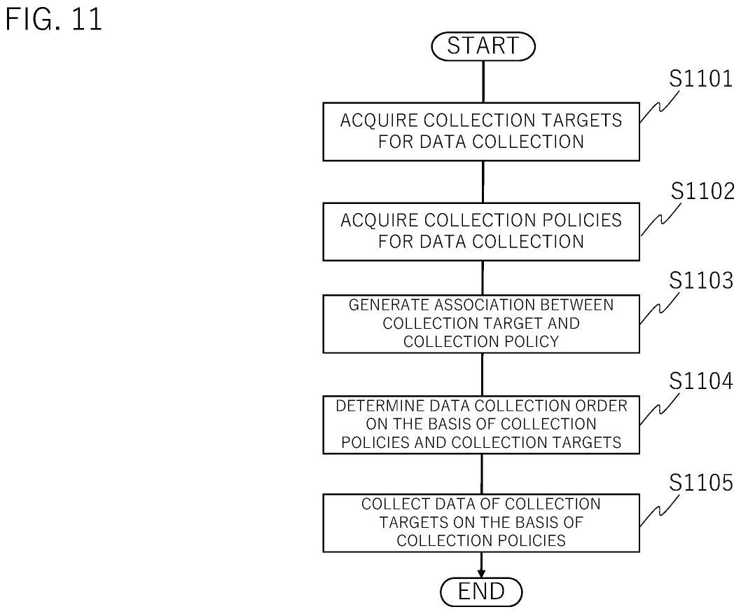

FIG. 11 is a flowchart showing an example of the processing flow of the data collection apparatus of the present example embodiment. The processing flow of the data collection apparatus of the present example embodiment is characterized in that it includes a process of generating an association between a collection target and a collection policy (step S1103) after acquiring the collection targets (step S1101) and acquiring the collection policies for data collection (step S1102). Since the subsequent processing flow is the same as the processing flow in the example embodiment described above, the description thereof will be omitted.

The data collection apparatus of the present example embodiment is able to generate the collection policies. In addition, since it is possible to generate a collection policy according to the data status of a collection target, meaningful data can be obtained more efficiently.

Some or all of the example embodiments above can be described as the following Supplementary Notes. Each of the following Supplementary Notes, however, is merely an example of the present invention, and the present invention is not limited thereto.

### Supplementary Note 1

As the data collection apparatus relating to the first aspect.

### Supplementary Note 2

The data collection apparatus preferably according to Supplementary Note 1 further comprising a collection order determination part that determines the order in which data are collected on the basis of the collection policy applied by the collection part and the collection targets held by the collection target holding part.

### Supplementary Note 3

The data collection apparatus preferably according to Supplementary Note 1, wherein
the collection policy holding part holds a collection policy that parallelizes the processing of collection.

### Supplementary Note 4

The data collection apparatus preferably according to any one of Supplementary Notes 1 to 3, wherein
the collection policy holding part holds a collection policy that collects data in ascending order of processing time in a predetermined period of time.

### Supplementary Note 5

The data collection apparatus preferably according to any one of Supplementary Notes 1 to 3, wherein
the collection policy holding part holds a collection policy that collects data in descending order of processing time in a predetermined period of time.

### Supplementary Note 6

The data collection apparatus preferably according to Supplementary Note 1 further comprising an output part that outputs a history of the policies applied to the collection part and the collection targets.

### Supplementary Note 7

The data collection apparatus preferably according to Supplementary Note 1 further comprising an editing part that edits a schedule of the policies applied to the collection part and the collection targets.

### Supplementary Note 8

The data collection apparatus preferably according to Supplementary Note 1 or 2 further comprising an association generation part that generates an association between the collection target and the collection policy, wherein
the collection part collects the data of the collection target on the basis of the collection target and the collection policy associated with each other.

### Supplementary Note 9

As the data collection method relating to the second aspect.

### Supplementary Note 10

As the program relating to the third aspect.

Further, like Supplementary Note 1, Supplementary Notes 9 and 10 can be developed into Supplementary Notes 2 to 8.

Further, the disclosure of Patent Literature cited above is incorporated herein in its entirety by reference thereto. It is to be noted that it is possible to modify or adjust the example embodiments or examples within the whole disclosure of the present invention (including the Claims) and based on the basic technical concept thereof. Further, it is possible to variously combine or select (or partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without explicit recital thereof.

### REFERENCE SIGNS LIST

10: data collection apparatus
11: collection target holding part
12: collection policy holding part
13: collection part
14: collection order determination part
15: output part
16: editing part
17: association generation part
91: CPU
92: memory
93: input/output interface
94: NIC
95: internal bus

What is claimed is:

1. A data collection apparatus comprising:
a processor, and
a memory in communication with the processor to store instructions performed by the processor, wherein the processor is configured to implement:
a collection target holding part that holds collection targets for data collection;
a collection policy holding part that holds collection policies for data collection; and
a collection part that collects data from the collection targets on the basis of the collection policies, wherein
the collection part collects data by switching the collection policy to be applied on the basis of another collection policy that is different from the collection policies and that defines how the collection policies are applied.

2. The data collection apparatus according to claim 1, wherein the processor is configured to further implement a collection order determination part that determines the order in which data are collected on the basis of the collection policy applied by the collection part and the collection targets held by the collection target holding part.

3. The data collection apparatus according to claim 1, wherein
the collection policy holding part holds a collection policy that parallelizes the processing of collection.

4. The data collection apparatus according to claim 1, wherein
the collection policy holding part holds a collection policy that collects data in ascending order of processing time in a predetermined period of time.

5. The data collection apparatus according to claim 1, wherein
the collection policy holding part holds a collection policy that collects data in descending order of processing time in a predetermined period of time.

6. The data collection apparatus according to claim 1, wherein the processor is configured to further implement an output part that outputs a history of the policies applied to the collection part and the collection targets.

7. The data collection apparatus according to claim 1, wherein the processor is configured to further implement an editing part that edits a schedule of the policies applied to the collection part and the collection targets.

8. The data collection apparatus according to claim 1, wherein the processor is configured to further implement an association generation part that generates an association between the collection target and the collection policy, wherein
the collection part collects data from the collection target on the basis of the collection target and the collection policy associated with each other.

9. The data collection apparatus according to claim 2, wherein
the collection policy holding part holds a collection policy that collects data in descending order of processing time in a predetermined period of time.

10. The data collection apparatus according to claim 3, wherein
the collection policy holding part holds a collection policy that collects data in descending order of processing time in a predetermined period of time.

11. The data collection apparatus according to claim 2, wherein the processor is configured to further implement an association generation part that generates an association between the collection target and the collection policy, wherein
the collection part collects data from the collection target on the basis of the collection target and the collection policy associated with each other.

12. A data collection method, comprising:
causing a computer to acquire collection targets for data collection;
causing the computer to acquire collection policies for data collection;
causing the computer to collect data from the collection targets on the basis of the collection policies; and
collecting the data by switching the collection policy to be applied on the basis of another collection policy that is different from the collection policies and that defines how the collection policies are applied.

13. The data collection method according to claim 12 further comprising determining the order in which data are collected on the basis of the collection policy applied by the collecting the data and the collection targets held by the collection target holding.

14. The data collection method according to claim 12, wherein the collection policy holding holds a collection policy that parallelizes the processing of collection.

15. The data collection method according to claim 12, wherein
the collection policy holding holds a collection policy that collects data in ascending order of processing time in a predetermined period of time.

16. The data collection method according to claim 12, wherein
the collection policy holding holds a collection policy that collects data in descending order of processing time in a predetermined period of time.

17. The data collection method according to claim 12, further comprising outputting a history of the policies applied to the collecting the data and the collection targets.

18. The data collection method according to claim 12, further comprising editing a schedule of the policies applied to the collecting the data and the collection targets.

19. The data collection method according to claim 12, further comprising an association generation that generates an association between the collection target and the collection policy, wherein
the collecting the data collects from the collection target on the basis of the collection target and the collection policy associated with each other.

20. A non-transitory computer-readable recording medium storing thereon a program configured to cause a computer to execute:
a process of acquiring collection targets for data collection;
a process of acquiring collection policies for data collection;
a process of collecting data from the collection targets on the basis of the collection policies; and
a process of collecting the data by switching the collection policy to be applied on the basis of another collection policy that is different from the collection policies and that defines how the collection policies are applied.
